(19) United States
(12) Patent Application Publication
(10) Pub. No.: US 2025/0103292 A1
(43) Pub. Date: Mar. 27, 2025

(54) Matrix Multiplier Caching

(71) Applicant: Apple Inc., Cupertino, CA (US)

(72) Inventors: David K. Li, Austin, TX (US); Christopher A. Burns, Austin, TX (US); Daniel E. Barnard, Hemel Hempstead (GB); Evan R. Lissoos, Austin, TX (US)

(21) Appl. No.: 18/426,020

(22) Filed: Jan. 29, 2024

Related U.S. Application Data
(60) Provisional application No. 63/585,873, filed on Sep. 27, 2023.

(51) Int. Cl. G06F 7/544; G06F 7/501; G06F 17/16

(52) U.S. Cl. CPC G06F 7/5443; G06F 7/5013; G06F 17/16

(57) ABSTRACT

Techniques are disclosed relating to integrated circuits that support matrix operations. In various embodiments, an integrated circuit comprises a dot product accumulate circuit that includes a dot product circuit configured to determine a dot product of a first vector and a second vector, and an adder circuit coupled to an output of the dot product circuit and configured to add a result of the dot product and an accumulation value. The integrated circuit further includes an accumulator cache coupled to an input of the adder circuit and an output of the adder circuit. The accumulator cache is configured to provide the accumulation value to the adder circuit and store a result of the add as a subsequent accumulation value for a subsequent dot product accumulate operation.

The present application claims priority to U.S. Prov. Appl. No. 63/585,873, entitled “Matrix Multiplier Caching,” filed Sep. 27, 2023, which is incorporated by reference herein in its entirety.

### BACKGROUND

### Technical Field

This disclosure relates generally to processors, and, more specifically, to performing matrix operations using processor hardware.

### Description of the Related Art

Some computing tasks rely heavily on matrix operations. These tasks can include those related to graphics processing such as rendering, shading, lighting, texturing, etc. Matrix operations are also frequently used in various machine learning algorithms such as those involving various types of neural networks. To provide support for these types of tasks, designers of central processing units (CPUs) and/or graphics processing units (GPUs) may define instructions in their instruction set architectures (ISAs) for performing matrix operations. As the complexities of these tasks increase, demand on the underlying hardware to perform matrix operations efficiently has also increased.

### BRIEF DESCRIPTION OF THE DRAWINGS

FIG. 1 is a block diagram illustrating an exemplary integrated circuit that includes a matrix multiplier with a dot product accumulate circuit using an accumulator cache.

FIG. 2 is a block diagram illustrating an exemplary arrangement dot product accumulate circuits and their respective accumulator caches within the matrix multiplier.

FIG. 3 is a block diagram illustrating an example of components within a dot product accumulate circuit.

FIG. 4 is a block diagram illustrating an exemplary accumulator cache with multiple entries for storing results.

FIG. 5 is a block diagram illustrating an example of intelligent scheduling using a complier that can provide hints to support use of the accumulator caches.

FIG. 6 is a flow diagram illustrating exemplary method performed by the matrix multiplier.

FIG. 7 is a flow diagram illustrating exemplary method performed by the complier.

FIG. 8 is a block diagram illustrating an exemplary computing device implementing functionality described herein.

FIG. 9 is a diagram illustrating exemplary applications for systems and devices implementing functionality described herein.

FIG. 10 is a block diagram illustrating an exemplary computer-readable medium that stores circuit design information for implementing devices having functionality described herein.

### DETAILED DESCRIPTION

In linear algebra, a matrix multiplication typically includes performing a dot product for each combination of rows in a first matrix and columns in second matrix in which 1) each value of a given row is multiplied by a respective value in a given column and 2) the resulting products are then summed. It may also be desirable to further add an offset/accumulation value to this sum. For example, in neural networks, calculating a perceptron includes adding a bias wo to a dot product of an input vector with a vector of ω weights. This type of operation is called a dot product accumulate and is supported in some GPU architectures by an instruction set architecture (ISA) defined instruction.

In some instances, workloads include matrix multiplications that are dependent on one another where the output of one dot product accumulate is used as an accumulation input operand for another dot product accumulate. For example, in recurrent neural networks (RNNs), a first dot product of an input vector and a weight vector can be added to the result of a second dot product of a historical vector and a weight vector. If instructions for dependent dot product accumulates are scheduled successively, however, a pipeline stall can occur in the processor executing the instructions as the result of the first dot product accumulate is written back and then retrieved from the register file—a time consuming process.

The present disclosure describes embodiments in which a cache is used to locally store the result of a first dot product accumulate so that the result can be immediately used for a second dependent dot product accumulate without taking the latency hit incurred to retrieve the result from the register file. As will be described below in various embodiments, an integrated circuit can include a dot product accumulate circuit and an accumulator cache. The dot product accumulate circuit can include a dot product circuit configured to determine a dot product of a first and second vector and an adder circuit configured to add a result of the dot product and an accumulation value. The accumulator cache is configured to store a result of the add as an accumulation value for a subsequent dot product accumulate operation. Accordingly, when a dependency exists for a second dot product accumulate, the accumulator cache is configured to provide the accumulation value to the adder circuit without having to access the register file storing, for example, the first and second vectors.

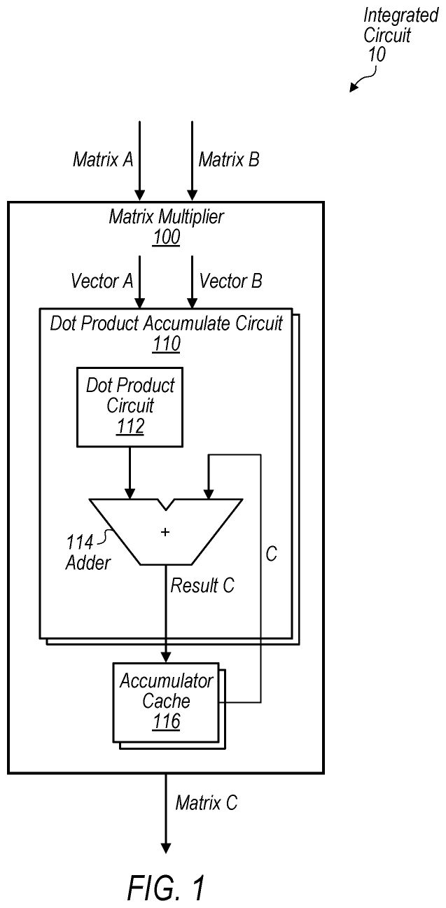

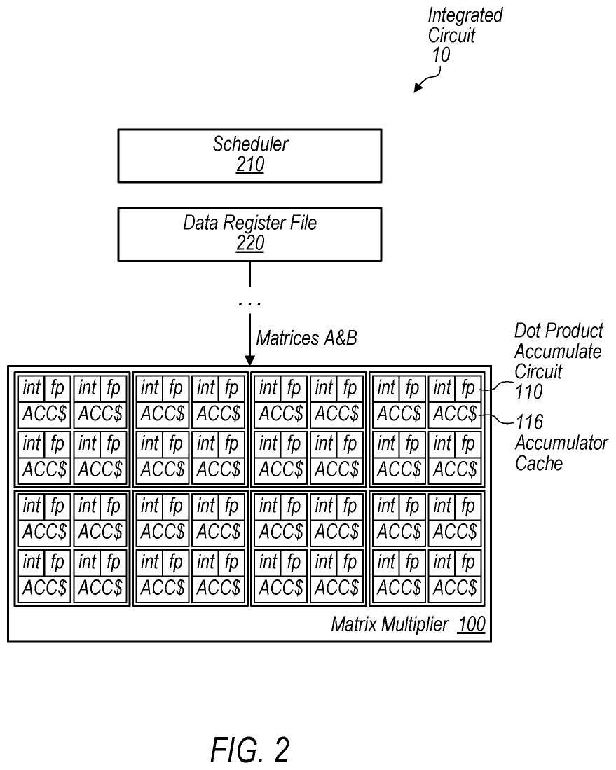

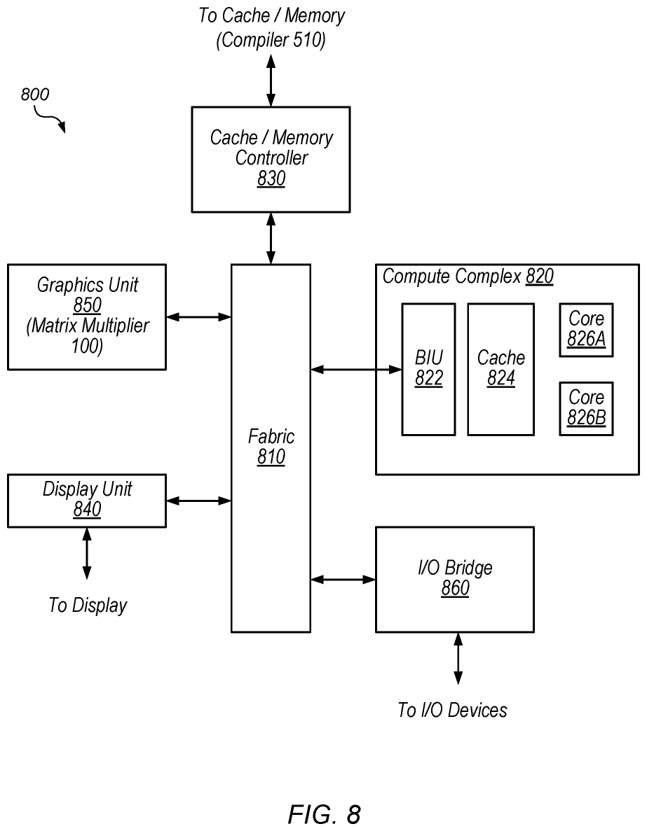

Turning now to FIG. 1, a block diagram of an integrated circuit 10 configured to support matrix multiplication is depicted. In the illustrated embodiment, integrated circuit 10 includes a matrix multiplier 100, which includes multiple dot product accumulate circuits 110. Circuit 110 further includes dot product circuit 112, an adder 114, and an accumulator cache 116. In some embodiments, integrated circuit 10 may be implemented differently than shown such as including multiple additional components such as discussed with FIGS. 2 and 8.

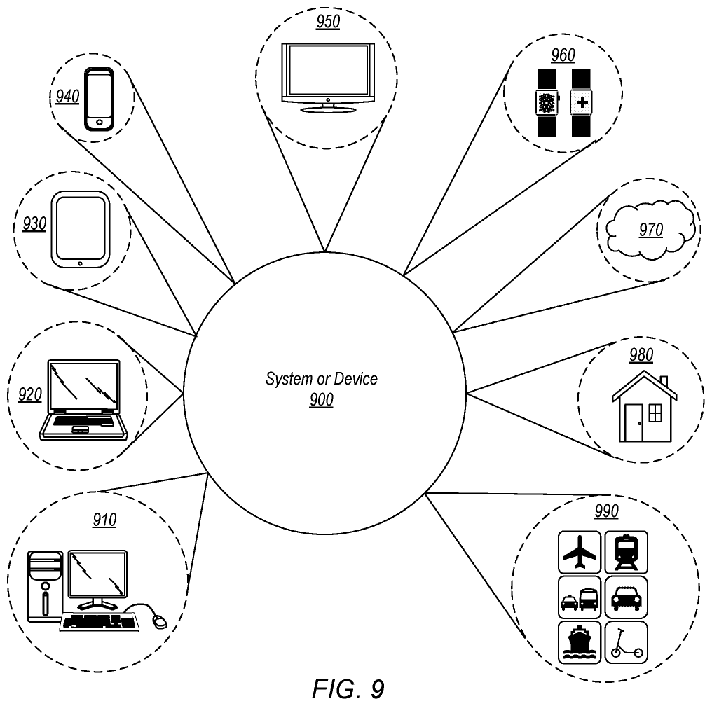

Integrated circuit (IC) 10 can correspond to any suitable circuitry configured to perform matrix-related operations such as a dot product accumulate operation. In some embodiments, integrated circuit 10 is a central processing unit (CPU), application-specific integrated circuit (ASICs), a system on a chip (SoC), field-programmable gate arrays (FPGAs), etc. In some embodiments, IC 10 is a GPU that can perform graphics-related tasks (e.g., rendering) by executing matrix multiply instructions. In some embodiments, IC 10 is a neural engine that can execute matrix multiply instructions in parallel when training a machine learning model. Integrated circuit 10 can also be included in any suitable computing device such as a desktop computer, laptop computer, tablet computer, mobile computing device, or any of the other devices discussed below with respect to FIG. 9.

Matrix multiplier 100 is circuitry configured to perform various matrix-related operations, which may be performed in response to particular ISA defined instructions being executed by IC 10. In the illustrated embodiment, matrix multiplier 100 performs a dot product accumulate operation using dot product accumulate circuit 110. As shown, dot product accumulate circuit 110 includes dot product circuit 112 and adder 114. Dot product circuit 112 is circuitry configured to determine the initial dot product portion of the dot product accumulate operation between a first vector A and a second vector B, which may be vectors within larger matrices A and B being multiplied by matrix multiplier 100. Adder 114 is circuitry configured to add the dot product output produced by circuit 112 and an offset/accumulation value. As noted above, in some cases, matrix multiplier 100 may receive successive instructions to perform two dot product accumulates that are dependent on one another such that the output (shown as a result C) of performing the first dot product accumulate is used as the input accumulation value for the second dot product accumulate (shown result C being fed back into adder 114). For example, matrix multiplier 100 may receive successive instructions to calculate a first dot product of an input vector and a weight vector in recurrent neural network (RNN), as noted above, and add the resulting value to a second dot product of a historical vector and a weight vector in the RNN. If matrix multiplier 100 were to write the result of the first dot product back to memory (e.g., data register file 220 discussed below with FIG. 2) and then read the written back result for computation of the second dot product, the resulting travel time to reuse this value would likely result in matrix multiplier 100 incurring a pipeline stall and taking a performance hit.

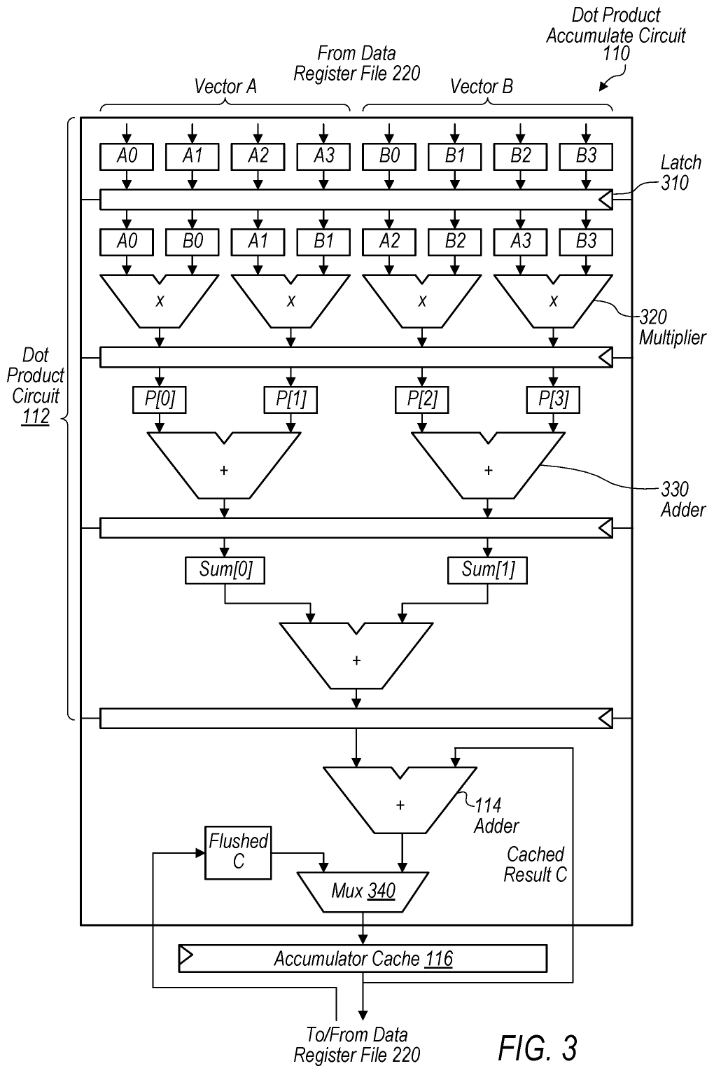

In the illustrated embodiment, however, an accumulator cache 116 is coupled to an output of dot product accumulate circuit 110 in order to store the intermediate result of a first instruction and provide it back to circuit 110 when executing a second dependent instruction. As a result, a stall can be avoided when executing a set of dependent instructions. As shown, if circuit 110 executes a second instruction dependent on the results of the first instruction, accumulator cache 116 provides the dot product from the first instruction to adder 114, which can sum the output from dot product circuit 112 for a subsequent instruction with a cached result C in order to determine a subsequent dot product accumulate. Accumulator cache 116 is discussed in greater detail with respect to FIG. 3.

An arrangement of multiple multiply circuits and respective caches will now be discussed with respect to FIG. 2.

Turning now to FIG. 2, a block diagram of additional components in integrated circuit 10 is shown. In the illustrated embodiment, integrated circuit 10 includes scheduler 210, data register file 220, and matrix multiplier 100 including multiple dot product accumulate circuits 110 and accumulator caches 116. In some embodiments, IC 10 is implemented differently than shown. As an example, matrix multiplier 100 may include two separate accumulator caches 116 for integer and floating-point circuits 110.

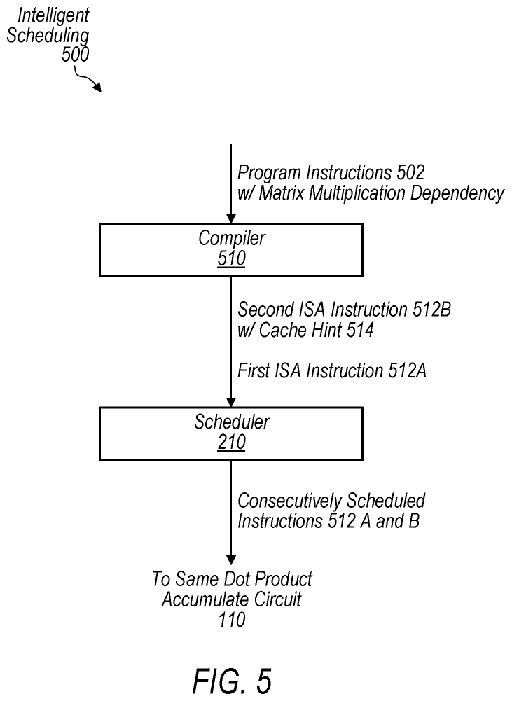

Scheduler 210 is circuitry configured to schedule program instruction for execution on various execution units such as matrix multiplier 100 including particular dot product accumulate circuits 110. As scheduler 210, in some embodiments, resides in a single instruction multiple data (SIMD) processor, scheduler 210 may have fewer capabilities than a CPU scheduler that is permitted to occupy a larger portion of die space. For example, scheduler 210 may lack the ability (or possess limited ability) to identify instruction dependencies and schedule accordingly, which may reduce the ability to utilize accumulator cache 116. As will be discussed with below FIG. 5, however, scheduler 210 may support the ability to receive “hints” generated by a compiler that can identify dependencies. Accordingly, when the compiler determines a dependency exists between two or more instructions, it provides an indication to scheduler 210, which can then schedule the two instructions to execute in sequential order to utilize cache 116.

In the illustrated embodiment, matrix multiplier 100 includes thirty-two execution lanes with each lane having an available dot product accumulate circuit 110 and a corresponding accumulator cache 116. When executing an instruction, matrix multiplier 100 receives matrices A and B from a register of data register file 220 including an array of registers used for data storage. In some embodiments, matrix multiplier 100 may then load elements from matrices A and B into a source cache for a particular lane prior to performing a matrix operation. In order to support integer and floating point operations, in various embodiments, matrix multiplier 100 includes separate integer (int) dot product accumulate circuits 110 and floating-point (fp) dot product accumulate circuits 110 with the logic/circuitry for handling these distinct data types. In the illustrated embodiment, a given accumulator cache 116 is shared between an integer dot product accumulate circuit 110 and a floating-point dot product accumulate circuit 110 as a given data path may be used to only execute instructions of one data type at a time. In other embodiments, the accumulator caches 116 may be included within dot product accumulate circuit 110s such that floating-point dot product accumulate circuits have a separate accumulator cache 116 from caches 116 included within integer dot product accumulate circuits 110.

As die space can limit the total number of available lanes/circuits 110, in various embodiments, matrix multiplier 100 may implement some matrix multiplications by performing multiple passes through circuits 110 with each pass processing different portions of matrices A and B. For example, in one embodiment, the 32 circuits 110 depicted in FIG. 2 can operate on 128 elements in a matrix at a given time. If, however, an instruction has been received to multiply 16×16 matrices (a total of 256 elements in a matrix), matrix multiplier 100 can perform a first pass in which it sends a first portion of the first and second matrices (an initial 128 elements per matrix) to the dot product accumulate circuits 110 to calculate a first partial set of results and send a second portion of the first and second matrices (the remaining 128 elements) to the dot product accumulate circuits 110 to calculate a second partial set of results. In some embodiments, the first and second portions are pipelined such that multiplier 100 can send the second portion of the first and second matrices to the dot product accumulate circuits 110 while the first partial set of results is being stored in accumulator caches 116.

The matrix operation performed by dot product accumulate circuit 110 is further described with respect to FIG. 3.

Turning now to FIG. 3, a block diagram of dot product accumulate circuit 110 is depicted. In the illustrated embodiment, circuit 110 includes a dot product circuit 112, an adder 114, mux 340, and an accumulator cache 116. As further depicted, the dot product circuit 112 includes a plurality of latches 310, multipliers 320, and adders 330. In some embodiments, circuit 110 is implemented differently than shown. For example, although FIG. 3 depicts circuit 110 supporting a dot product accumulate between two vectors A and B each having four elements, circuit 110 may support dot products having greater (or fewer) numbers of elements such an 8-way dot product accumulate, 16-way dot product accumulate, etc. As another example, circuit 110 may include cache 116.

As previously discussed, dot product accumulate circuit 110 receives vector A and vector B from data register file 220. As shown, input vector A can include elements A0, A1, A2, and A3;input vector B can include elements B1, B1, B2, and B3, which may be integer or floating-point values of any suitable size. After latch 310 receives elements A0-3 and B0-3, latch 310 releases the elements to multipliers 320. Before these elements arrive at multipliers 320, a permute network in circuit 112 may transpose the elements from vectors A and B in preparation for multipliers 320 so that an element from vector A is paired with its corresponding element from vector B.

Multipliers 320 are configured to perform a multiplication operation in which an element from a row of vector A is multiplied with the corresponding element from a column of vector B. For example, the first element (e.g., A0) from vector A is multiplied by the first element (e.g., B0) from vector B, and the second element (e.g., A1) from vector A is multiplied by the second element (e.g., B1) from vector B. As shown, circuit 112 includes a multiplier 320 for each element pair (A0 and B0, A1 and B1, A2 and B2, A3 and B3) to produce results P[0], P[1], P[2], and P[3],respectively. In other embodiments, circuit 110 may include different numbers of multipliers 320 to facilitate the multiplication operation based on the number of element pairs from vector A and B. When an output is generated from one of the multipliers 320, it is temporarily stored in a second latch 310 until each multiplier 320 has produced its respective output. After receiving all outputs from multiplier 320, the second latch 310 releases the results to adders 330.

Adders 330 are configured to perform addition operations in which the outputs of multipliers 320 are sum. As shown, P[0] and P[1] are used as inputs for a first adder 330 and produce an output of Sum[0]; P[2] and P[3] are used by a second adder 330 and produce an output of Sum[1]. In other embodiments, circuit 112 may include different numbers of adders 330 based on the number of outputs received from multipliers 320. After receiving all outputs from the initial two adders 330, the third latch 310 releases the results to a final adder 330 to add Sum[0] and Sum[1] of circuit 112 to produce the dot product of vectors A and B.

Adder 114 is configured to perform an addition operation in which it sums the output of dot product circuit 112 with a cached accumulation value shown as result C. In instances in which successive dependent instructions are being executed, this cached result C from cache 116 is the previous output of adder 114 after passing through multiplexer 340 to cache 116 for storage and reuse. In other instances, however, multiplexer 340 is configured to select a different input in order to route a different value from data register file 220 into accumulator cache 116 such as previously flushed result C or some other value being added to the dot product result produced by dot product circuit 112.

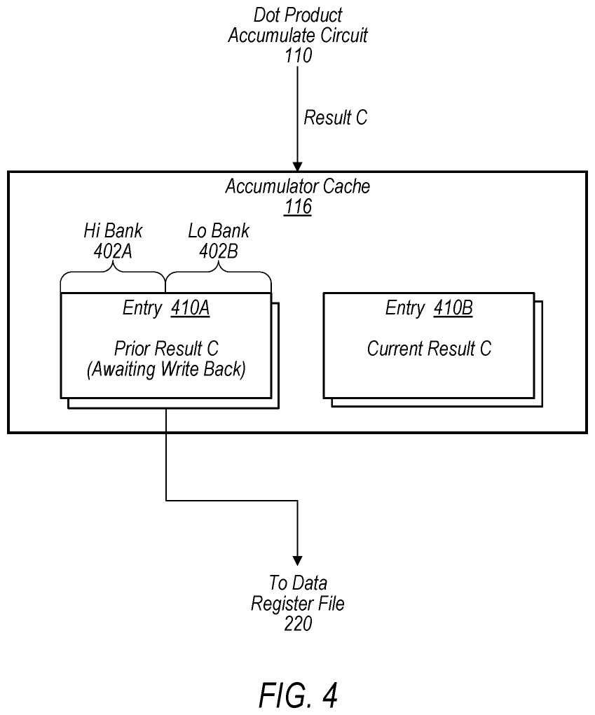

Accumulator cache 116 is described in greater detail with respect to FIG. 4.

Turning now to FIG. 4, a block diagram of accumulator cache 116 is depicted. In the illustrated embodiment, accumulator cache 116 includes multiple entries 410 including an entry 410A and an entry 410B. In some embodiments, accumulator cache 116 is implemented differently than shown. For example, accumulator cache 116 may store additional entries from dot product accumulate circuit 110, include additional read ports to read portions of an entry 410 at a finer level of granularity, etc.

As previously discussed, accumulator cache 116 is a local memory for receiving and storing elements from the dot product (e.g., result C) produced from circuit 110. Because it takes time for accumulator cache 116 to write back a dot product accumulate to a register of data register file 220, a result C of a subsequent dot product accumulate may become available for storage in cache 116 prior to the writeback completing. In order to avoid stalling the pipeline to perform a write back to a register of data register file 220, accumulator cache 116 is double buffered allowing cache 116 to read a current result C (e.g., entry 410B) while performing a write back of a prior result C (e.g., entry 410A). This double buffering may also be used for a cache load in which cache 116 may read a prior flushed result C (or some other value being used as accumulate value) from a register of data register file 220 while simultaneously writing back the previous result C to another register. In this situation, one of entries 410 may provide an input to adder 114 for a first instruction while the second entry 410 is used to writeback the output of a second instruction.

As shown, each entry 410 can further be partitioned into a hi bank 402A and lo bank 402B, which can allow for greater read/write granularity matching. In some embodiments, this ability to independently read hi and lo banks 402 may also allow for early data evictions from cache 116.

Turning now to FIG. 5, a block diagram of intelligent scheduling 500 is depicted. In the illustrated embodiment, intelligent scheduling 500 includes a compiler 510 and a scheduler 210. In some embodiments, intelligent scheduling 500 is implemented differently than shown.

Compiler 510 is software executable to compile program instruction 502 written in a higher-level language into an ISA defined instructions 512 supported by IC 10. As noted above, scheduler 210 may not possess the ability (or may possess only a limited ability) to identify instruction dependencies. In the illustrated embodiment, compiler 510 is executable to identify dot product accumulate instructions that are dependent on one another and provide a cache hint 514 indicative of the dependency to scheduler 210. As shown, compiler 510 receives program instructions 502 with a matrix multiplication dependency such as dot product accumulate dependency. In response to compiling instructions 502 and identifying a dependency between first and second instructions, compiler 510 provides a corresponding cache hint 514 indicating that the first and second instructions 512 should be successively scheduled to immediate re-use of an accumulator value. Hint 412 may be conveyed using any suitable approach such as modifying the instruction's opcode, modifying an operand input, etc. In response to receiving a hint 514 associated with instructions 512A and 512B, scheduler 210 is configured to schedule instructions 512A and 512B one after the other on the same dot product accumulate circuit 110 to ensure that the cached result C is reused.

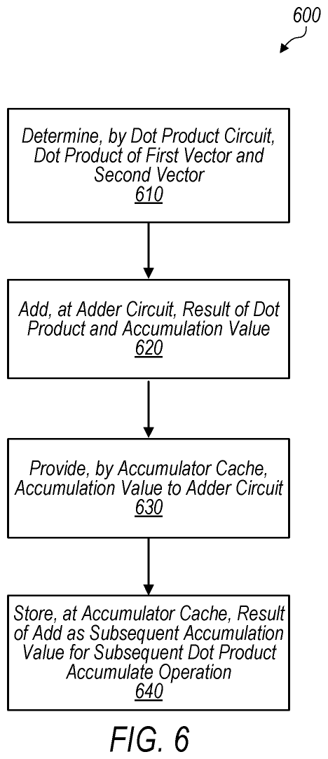

Turning now to FIG. 6, a flow diagram of a method 600 is depicted. Method 600 is one embodiment of a method that may be performed by an integrated circuit device such as integrated circuit 10. In many instances, performance of method 600 may reduce the likelihood of a pipeline stall when a matrix multiplier circuit (e.g., matrix multiplier 100) is executing a dot product accumulate instruction with a dependency.

In step 610, the dot product circuit (e.g., dot product circuit 112) determines a dot product of a first vector and second vector. In various embodiments, the matrix multiplier circuit includes a plurality of dot product accumulate circuits (e.g., dot product accumulate circuit 110). The matrix multiplier circuit sends a first portion of the first and second matrices to the dot product accumulate circuits to calculate a first partial set of results. While storing the first partial set of results in a plurality of accumulator caches, the matrix multiplier sends a second portion of the first and second matrices to the dot product accumulate circuits to calculate a second partial set of results. In some embodiments, the dot product accumulate circuit performs an integer dot product accumulate, and a second dot product accumulate circuit performs a floating point dot product accumulate. In some embodiments, the integrated circuit is a single instruction multiple data (SIMD) processor. In other embodiments, the integrated circuit is a graphics processing unit.

In step 620, the adder circuit (e.g., adder 114) adds a result of the dot product and an accumulation value. In some embodiments, step 620 may be performed after step 630. In step 630, the accumulator cache (e.g., accumulator cache) provides the accumulation value to the adder circuit. In some embodiments, the integrated circuit comprises a scheduler circuit (e.g., scheduler 210). The scheduler circuit receives compiled first (e.g., first ISA instruction 512A) and second program instructions (e.g., second ISA instruction 512B) with an indication (e.g., cache hint 514) from a compiler (e.g., compiler 510) that the second program instruction is dependent on a dot product accumulate result of the first program instruction. The scheduler circuit consecutively schedules the first and second program instructions for execution by the dot product accumulate circuit to cause the accumulator cache to provide the dot product accumulate result as an input operand for execution of the second program instruction.

In step 640, the accumulator cache stores a result of the add as a subsequent accumulation value for a subsequent dot product accumulate operation. The accumulator cache stores the result of the add in a first entry (e.g., entry 410B) of the cache while performing a write back of a previous stored result from a second entry (e.g., entry 410A) of the accumulator cache to a register file (e.g., data register file 220). The accumulator cache provides stored results to adder circuits in both dot product accumulate circuits. The register file circuitry store values of first and second matrices including the first and second vectors. The accumulator cache is located closer to the adder than the register file circuitry.

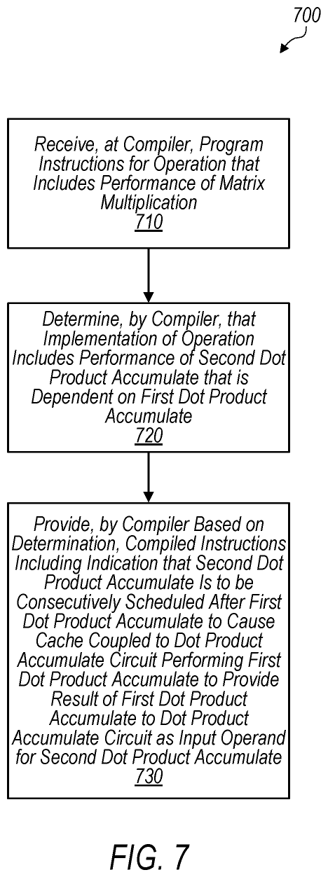

Turning now to FIG. 7, a flow diagram of a method 700 is depicted. Method 700 is one embodiment of a method that may be performed by an integrated circuit device such as integrated circuit 10. In many instances, performance of method 700 may reduce the likelihood of a pipeline stale when a matrix multiplier circuit (e.g., matrix multiplier 100) is executing a dot product accumulate instruction with a dependency.

In step 710, the compiler (e.g., compiler 510) receives program instructions (e.g., program instructions 502) for an operation that includes performance of a matrix multiplication. In step 720, the compiler determines that implementation of the operation includes performance of a second dot product accumulate that is dependent on a first dot product accumulate. In step 730, the compiler provides, based on the determination, compiled instructions that include an indication (e.g., cache hint 514) that the second dot product accumulate is to be consecutively scheduled after the first dot product accumulate to cause a cache coupled to a dot product accumulate circuit performing the first dot product accumulate to provide a result of the first dot product accumulate to the dot product accumulate circuit as an input operand for the second dot product accumulate.

### Exemplary Computer System

Turning now to FIG. 8, a block diagram illustrating an example embodiment of a device 800 is shown. In some embodiments device 800 may include (or correspond to) integrated circuit 10 and/or implement functionality of matrix multiplier 100. In some embodiments, elements of device 800 may be included within a system on a chip. In some embodiments, device 800 may be included in a mobile computing device, which may be battery-powered. Therefore, power consumption by device 800 may be an important design consideration. In the illustrated embodiment, device 800 includes fabric 810, compute complex 820 input/output (I/O) bridge 860, cache/memory controller 830, graphics unit 840, and display unit 850. In some embodiments, device 800 may include other components (not shown) in addition to or in place of the illustrated components, such as video processor encoders and decoders, image processing or recognition elements, computer vision elements, etc.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol and elements coupled to fabric 810 may convert from the single communication protocol to other communication protocols internally.

In the illustrated embodiment, compute complex 820 includes bus interface unit (BIU) 822, cache 824, and cores 826A-B. In various embodiments, compute complex 820 may include various numbers of processors, processor cores and caches. For example, compute complex 820 may include 1, 2, or 4 processor cores, or any other suitable number. In one embodiment, cache 824 is a set associative L2 cache. In some embodiments, cores 826A-B may include internal instruction and data caches. In some embodiments, a coherency unit (not shown) in fabric 810, cache 824, or elsewhere in device 800 may be configured to maintain coherency between various caches of device 800. BIU 822 may be configured to manage communication between compute complex 820 and other elements of device 800. Processor cores such as cores 826A-B may be configured to execute instructions of a particular instruction set architecture (ISA) which may include operating system instructions and user application instructions. These instructions may be stored in computer readable medium such as a memory coupled to memory controller 830 discussed below.

As used herein, the term “coupled to” may indicate one or more connections between elements, and a coupling may include intervening elements. For example, in FIG. 8, graphics unit 840 may be described as “coupled to” a memory through fabric 810 and cache/memory controller 830. In contrast, in the illustrated embodiment of FIG. 8, graphics unit 840 is “directly coupled” to fabric 810 because there are no intervening elements.

Cache/memory controller 830 may be configured to manage transfer of data between fabric 810 and one or more caches and memories. For example, cache/memory controller 830 may be coupled to an L3 cache, which may in turn be coupled to a system memory. In other embodiments, cache/memory controller 830 may be directly coupled to a memory. In some embodiments, cache/memory controller 830 may include one or more internal caches. Memory coupled to controller 830 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 830 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as compiler 510, executable by compute complex 820 to cause device 800 to perform functionality described herein.

Graphics unit 840 may include one or more processors, e.g., one or more graphics processing units (GPUs). Graphics unit 840 may receive graphics-oriented instructions, such as OPENGL®, Metal®, or DIRECT3D® instructions, for example. Graphics unit 840 may execute specialized GPU instructions or perform other operations based on the received graphics-oriented instructions. Graphics unit 840 may generally be configured to process large blocks of data in parallel and may build images in a frame buffer for output to a display, which may be included in the device or may be a separate device. Graphics unit 840 may include transform, lighting, triangle, and rendering engines in one or more graphics processing pipelines. Graphics unit 840 may output pixel information for display images. Graphics unit 840, in various embodiments, may include programmable shader circuitry which may include highly parallel execution cores configured to execute graphics programs, which may include pixel tasks, vertex tasks, and compute tasks (which may or may not be graphics-related). In some embodiments, graphics unit 840 includes matrix multiplier 100 discussed above.

Display unit 850 may be configured to read data from a frame buffer and provide a stream of pixel values for display. Display unit 850 may be configured as a display pipeline in some embodiments. Additionally, display unit 850 may be configured to blend multiple frames to produce an output frame. Further, display unit 850 may include one or more interfaces (e.g., MIPI® or embedded display port (eDP)) for coupling to a user display (e.g., a touchscreen or an external display).

I/O bridge 860 may include various elements configured to implement: universal serial bus (USB) communications, security, audio, and low-power always-on functionality, for example. I/O bridge 860 may also include interfaces such as pulse-width modulation (PWM), general-purpose input/output (GPIO), serial peripheral interface (SPI), and inter-integrated circuit (I2C), for example. Various types of peripherals and devices may be coupled to device 800 via I/O bridge 860.

In some embodiments, device 800 includes network interface circuitry (not explicitly shown), which may be connected to fabric 810 or I/O bridge 860. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 800 with connectivity to various types of other devices and networks.

### Example Applications

Turning now to FIG. 9, various types of systems that may include any of the circuits, devices, or system discussed above. System or device 900, which may incorporate or otherwise utilize one or more of the techniques described herein, may be utilized in a wide range of areas. For example, system or device 900 may be utilized as part of the hardware of systems such as a desktop computer 910, laptop computer 920, tablet computer 930, cellular or mobile phone 940, or television 950 (or set-top box coupled to a television).

Similarly, disclosed elements may be utilized in a wearable device 960, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 900 may also be used in various other contexts. For example, system or device 900 may be utilized in the context of a server computer system, such as a dedicated server or on shared hardware that implements a cloud-based service 970. Still further, system or device 900 may be implemented in a wide range of specialized everyday devices, including devices 980 commonly found in the home such as refrigerators, thermostats, security cameras, etc. The interconnection of such devices is often referred to as the “Internet of Things” (IoT). Elements may also be implemented in various modes of transportation. For example, system or device 900 could be employed in the control systems, guidance systems, entertainment systems, etc. of various types of vehicles 990.

The applications illustrated in FIG. 9 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a computing system configured to generate a simulation model of the hardware circuit, by a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

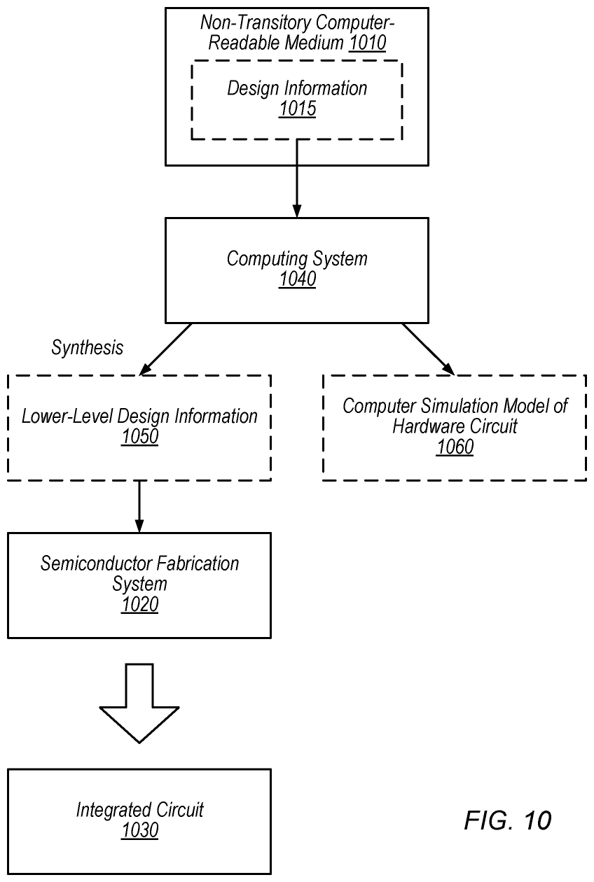

Turning now to FIG. 10, a block diagram of an example non-transitory computer-readable storage medium that stores circuit design information is depicted. In the illustrated embodiment, computing system 1040 is configured to process the design information. This may include executing instructions included in the design information, interpreting instructions included in the design information, compiling, transforming, or otherwise updating the design information, etc. Therefore, the design information controls computing system 1040 (e.g., by programming computing system 1040) to perform various operations discussed below, in some embodiments.

In the illustrated example, computing system 1040 processes the design information to generate both a computer simulation model of a hardware circuit 1060 and lower-level design information 1050. In other embodiments, computing system 1040 may generate only one of these outputs, may generate other outputs based on the design information, or both. Regarding the computing simulation, computing system 1040 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1040 also processes the design information to generate lower-level design information 1050 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1050 (potentially among other inputs), semiconductor fabrication system 1020 is configured to fabricate an integrated circuit 1030 (which may correspond to functionality of the simulation model 1060). Note that computing system 1040 may generate different simulation models based on design information at various levels of description, including information 1050, 1015, and so on. The data representing design information 1050 and model 1060 may be stored on medium 1010 or on one or more other media.

In some embodiments, the lower-level design information 1050 controls (e.g., programs) the semiconductor fabrication system 1020 to fabricate the integrated circuit 1030. Thus, when processed by the fabrication system, the design information may program the fabrication system to fabricate a circuit that includes various circuitry disclosed herein.

Non-transitory computer-readable storage medium 1010, may comprise any of various appropriate types of memory devices or storage devices. Non-transitory computer-readable storage medium 1010 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1010 may include other types of non-transitory memory as well or combinations thereof. Accordingly, non-transitory computer-readable storage medium 1010 may include two or more memory media; such media may reside in different locations—for example, in different computer systems that are connected over a network.

Design information 1015 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1040, semiconductor fabrication system 1020, or both. In some embodiments, design information may also include one or more cell libraries that specify the synthesis, layout, or both of integrated circuit 1030. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1030 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 and model 1060 are configured to operate according to a circuit design specified by design information 1015, which may include performing any of the functionality described herein. For example, integrated circuit 1030 may include any of various elements shown in FIGS. 1-8. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1020 to fabricate integrated circuit 1030.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An integrated circuit, comprising:
a dot product accumulate circuit that includes:
a dot product circuit configured to determine a dot product of a first vector and a second vector; and
an adder circuit coupled to an output of the dot product circuit and configured to add a result of the dot product and an accumulation value; and
an accumulator cache coupled to an input of the adder circuit and an output of the adder circuit, wherein the accumulator cache is configured to:
provide the accumulation value to the adder circuit; and
store a result of the add as a subsequent accumulation value for a subsequent dot product accumulate operation.

2. The integrated circuit of claim 1, wherein the accumulator cache is configured to:
store the result of the add in a first entry of the accumulator cache while performing a write back of a previous stored result from a second entry of the accumulator cache to a register file.

3. The integrated circuit of claim 1, further comprising:
a matrix multiplier circuit configured to multiply first and second matrices, wherein the matrix multiplier circuit includes a plurality of dot product accumulate circuits.

4. The integrated circuit of claim 3, wherein the matrix multiplier circuit is configured to:
send a first portion of the first and second matrices to the dot product accumulate circuits to calculate a first partial set of results; and
while storing the first partial set of results in a plurality of accumulator caches, send a second portion of the first and second matrices to the dot product accumulate circuits to calculate a second partial set of results.

5. The integrated circuit of claim 1, further comprising:
a scheduler circuit configured to:
receive compiled first and second program instructions with an indication from a compiler that the second program instruction is dependent on a dot product accumulate result of the first program instruction; and
consecutively schedule the first and second program instructions for execution by the dot product accumulate circuit to cause the accumulator cache to provide the dot product accumulate result as an input operand for execution of the second program instruction.

6. The integrated circuit of claim 1, further comprising:
register file circuitry configured to:
store values of first and second matrices including the first and second vectors; and
wherein the accumulator cache is located closer to the adder circuit than the register file circuitry.

7. The integrated circuit of claim 1, wherein the dot product accumulate circuit is configured to perform an integer dot product accumulate; and
wherein the integrated circuit further comprises a second dot product accumulate circuit configured to perform a floating point dot product accumulate.

8. The integrated circuit of claim 7, wherein the accumulator cache is configured to:
provide stored results to adder circuits in both dot product accumulate circuits.

9. The integrated circuit of claim 1, wherein the integrated circuit is a single instruction multiple data (SIMD) processor.

10. The integrated circuit of claim 1, wherein the integrated circuit is a graphics processing unit.

11. A method, comprising:
performing, by a computing device, a dot product accumulate that includes:
determining a dot product of a first vector and a second vector; and
adding, by an adder circuit, a result of the dot product and an accumulation value, wherein the accumulation value is provided by an accumulator cache coupled to the adder circuit; and
storing, in the accumulator cache, a result of the add as a subsequent accumulation value for a subsequent dot product accumulate operation.

12. The method of claim 11, wherein the storing includes:
storing the result of the add in a first entry of the accumulator cache while performing a write back of a previous stored result from a second entry of the accumulator cache to register file circuitry of the computing device.

13. The method of claim 12, wherein the accumulator cache is located closer to the adder circuit than the register file circuitry.

14. The method of claim 11, further comprising:
multiply, by the computing device, first and second matrices including the first and second vectors, wherein the multiplying includes performing the dot product accumulate.

15. The method of claim 11, further comprising:
receiving, by the computing device, compiled first and second program instructions with an indication from a compiler that the second program instruction is dependent on a dot product accumulate result of the first program instruction; and
consecutively scheduling, by the computing device, the first and second program instructions for execution to cause the accumulator cache to provide the dot product accumulate result as an input operand for execution of the second program instruction.

16. A non-transitory computer readable medium having instructions of a hardware description programming language stored thereon that, when processed by a computing system, program the computing system to generate a computer simulation model, wherein the model represents a hardware circuit that includes:
a dot product accumulate circuit that includes:
a dot product circuit configured to determine a dot product of a first vector and a second vector; and
an adder circuit coupled to an output of the dot product circuit and configured to add a result of the dot product and an accumulation value; and
an accumulator cache coupled to an input of the adder circuit and an output of the adder circuit, wherein the accumulator cache is configured to:
provide the accumulation value to the adder circuit; and
store a result of the add as a subsequent accumulation value for a subsequent dot product accumulate operation.

17. The computer readable medium of claim 16, wherein the accumulator cache is configured to:
store the result of the add in a first entry of the accumulator cache while writing back of a previous stored result from a second entry of the accumulator cache to a register file.

18. The computer readable medium of claim 16, wherein the hardware circuit includes:
a matrix multiplier circuit configured to multiply first and second matrices, wherein the matrix multiplier circuit includes a plurality of dot product accumulate circuits.

19. The computer readable medium of claim 16, wherein the hardware circuit includes:
a scheduler circuit configured to:
receive an indication from a compiler that a second program instruction is dependent on a dot product accumulate result of a first program instruction; and
consecutively schedule the first and second program instructions for execution by the dot product accumulate circuit.

20. The computer readable medium of claim 16, wherein the hardware circuit includes:
register file circuitry configured to:
store the first and second vectors, wherein the accumulator cache is located closer to the adder circuit than the register file circuitry.
